(19) United States
(12) Patent Application Publication
(10) Pub. No.: US 2023/0366628 A1
(43) Pub. Date: Nov. 16, 2023

(54) Hood-type annealing furnace and method for cooling an annealing material in a hood-type annealing furnace

(71) Applicant: SMS group GmbH, Düsseldorf (DE)

(72) Inventors: Frank MASCHLER, Duisburg (DE); Jörg ROSTEK, Bochum (DE); Hardy Maaß, Essen (DE); Andreas ELSING, Dorsten (DE)

(73) Assignee: SMS group GmbH, Düsseldorf (DE)

(21) Appl. No.: 18/030,644

(22) PCT Filed: Sep. 13, 2021
(86) PCT No.: PCT/EP2021/075028

§ 371 Date: Apr. 6, 2023

(30) Foreign Application Priority Data
Oct. 8, 2020 (DE) 10 2020 212 723.9

(51) Int. Cl. F27D 9/00; F27D 7/02; F27B 11/00

(52) U.S. Cl. CPC F27D 9/00; F27B 11/00; F27D 7/02; F27D 2009/0005; F27D 2009/0078

(57) ABSTRACT

A hood-type annealing furnace has a base, which has a site on which a batch of a annealing material can be arranged. The annealing material arranged on the site can be covered by a protective hood, which forms an annealing space enclosed by the protective hood and the site. The protective hood can be covered by a heating hood, thereby forming an intermediate space arranged between the heating hood and the protective hood and bounded at the bottom by the base. A cooling gas system is communicably connected or connectable to the intermediate space. The cooling gas system is communicably connected or connectable to the intermediate space, to a cooling gas outlet formed on the base and communicably connected to the intermediate space, and at least one cooling gas inlet formed on the base and communicably connected to the intermediate space.

### CROSS-REFERENCE TO RELATED APPLICATION

This application is a national stage application, filed under 35 U.S.C. § 371, of International Patent Application No. PCT/EP2021/075028, filed on 13-Sept-2021, which claims the benefit of German Patent Application No. 10 2020 212 723.9, filed 08-Oct-2020.

### BACKGROUND

Hood-type annealing furnaces are used, for example, for the high-temperature annealing of grain-oriented electrical steel strip, with which the electrical steel strip is annealed at very high temperatures between 1100° C. and 1200° C. For this purpose, the grain-oriented electrical steel strip is usually fed into a hood-type annealing furnace in batches, wherein a batch can be formed, for example, by an electrical steel strip wound into a coil or a stack of such coils. A grain-oriented electrical steel strip can be used, for example, to produce an iron core or a wound core, as the case may be, for an electrical machine, such as a transformer or a generator.

DE 10 2012 221 511 A1 discloses a cooling hood for a hood-type furnace for cooling annealing material previously heated with a heating hood, which is arranged for heating and for cooling inside a protective hood of the hood-type furnace. The cooling hood has a cooling hood body for fitting over the protective hood, a cooling gas feed opening in the cooling hood body for feeding cooling gas into an intermediate space between the protective hood and the cooling hood body, a cooling gas outlet opening in the cooling hood body for discharging fed cooling gas from the intermediate space, a closing device for selectively closing or at least partially opening the cooling gas outlet opening and a ventilating device for ventilating the cooling gas between the cooling gas feed opening and the cooling gas outlet opening.

EP 2 486 157 B1 discloses a hood-type annealing furnace for the high-temperature annealing of metal strip, sheet or wire, in particular grain-oriented electrical steel strip in the form of coils in an annealing space under inert gas or in an inert gas atmosphere in a hood-type furnace. The hood-type annealing furnace has a hearth with at least one site for a batch in the form of a coil or a coil stack, at least one protective hood that covers the batch and under which the annealing space is formed, a dynamic seal between the protective hood and the hearth, along with a heating hood that surrounds the protective hood with clearance and under which a heating space is formed. The heating hood has a plurality of burners operated with liquid or gaseous fuel, the flames of which are directed openly into the heating space. The hood-type annealing furnace has an emergency purging device for purging the annealing space under the protective hood and the heating space under the heating hood with inert gas, wherein one inert gas feed opens in the annealing space and one opens in the heating space.

Furthermore, it is known to equip a heating hood of a hood-type annealing furnace with a cooling system, which, however, leads to a relatively complicated structure of the heating hood, is accompanied by restrictions in the design of the heating device arranged on the heating hood and results in a very high weight of the heating hood, which can then only be moved with a powerful crane.

### SUMMARY

The disclosure relates to a hood-type annealing furnace for annealing annealing material, having at least one base, which has at least one site on which at least one batch of annealing material is able to be arranged, at least one protective hood, with which the annealing material arranged on the site is able to be covered, forming an annealing space enclosed by the protective hood and the site, at least one heating hood, with which the protective hood is able to be covered, forming an intermediate space arranged between the heating hood and the protective hood and bounded at the bottom by the base, and at least one cooling gas system that is communicably connected or connectable to the intermediate space.

In addition, the disclosure relates to a method for cooling an annealing material located in a hood-type annealing furnace by using a cooling gas that, for cooling the annealing material, is passed through an intermediate space formed between a protective hood of the hood-type annealing furnace, with which the annealing material arranged on a site of a base of the hood annealing furnace is covered, forming an annealing space enclosed by the protective hood and the site, and a heating hood of the hood-type annealing furnace, with which the protective hood is covered, such intermediate space bounded at the bottom by the base.

One object of the invention is to simplify the operation of a hood-type annealing furnace.

This object is achieved by the subject matter as claimed. Advantageous embodiments are reproduced in the following description, the dependent patent claims and the figure, wherein these embodiments can each in themselves or in combination of at least two of these embodiments with one another represent a further developing, in particular also preferred or advantageous aspect of the invention. Designs of the hood-type annealing furnace can correspond to designs of the method, and vice versa, even if this is not explicitly referred to in individual cases in the following.

An improved hood-type annealing furnace for annealing an annealing material, has at least one base, which has at least one site on which at least one batch of annealing material is able to be arranged, at least one protective hood, with which the annealing material arranged on the site is able to be covered, forming an annealing space enclosed by the protective hood and the site, at least one heating hood with which the protective hood is able to be covered, forming an intermediate space arranged between the heating hood and the protective hood and bounded at the bottom by the base, and at least one cooling gas system that is communicably connected or connectable to the intermediate space. The cooling gas system is communicably connected or connectable to the intermediate space to a cooling gas outlet formed on the base and communicably connected to the intermediate space and at least one cooling gas inlet formed on the base and communicably connected to the intermediate space.

The cooling gas system is independent of the heating hood, such that the weight of the heating hood is not increased by the cooling gas system. This allows the heating hood to be moved under a lower crane load, which simplifies the operation of the hood-type annealing furnace. In addition, the heating and cooling functions, or the components of the hood-type annealing furnace used for this purpose, as the case may be, are clearly separated from each other structurally, which makes the overall structure of the hood-type annealing furnace clearer and simpler, which also goes hand in hand with simplified operation.

Instead of the heating hood, the cooling gas system is connected to the base, which does not need to be moved to operate the hood-type annealing furnace. Two or more cooling gas outlets and/or two or more cooling gas inlets may also be formed on the base, through which the cooling gas system is communicably connected or connectable to the intermediate space. The respective cooling gas outlet or cooling gas inlet, as the case may be, can, for example, be formed as an aperture or through-hole on the base.

The base works together with the heating hood in order to close the intermediate space between the heating hood and the intermediate space arranged on the site of the base to the outside, if the heating hood is placed on the base and sealed against it. The base can also have two or more sites, on each of which at least one batch of the annealing material is able to be arranged.

The protective hood works together with the site or a section of the base surrounding the site, in order to seal the annealing space between the site or base, as the case may be, and the protective hood placed on the site or base, as the case may be, to the outside if the protective hood is placed on and sealed from the site or base, as the case may be. The hood-type annealing furnace has a separate or dedicated, as the case may be, protective hood for each site. If the respective protective hood is placed on the site or base, as the case may be, and the heating hood is placed on the base, the intermediate space between them is bounded by the heating hood, the protective hood and the base.

By means of the cooling gas system, a cooling gas can be passed through the intermediate space to cool the annealed annealing material, wherein the cooling gas cools the annealing material indirectly via the respective protective hood and a gas located in the annealing space.

The cooling gas system can be continuously communicating with the intermediate space. Alternatively, the cooling gas system can be connected to the intermediate space merely to carry out a cooling process; i.e., it is communicably connectable to the intermediate space as required by means of closing devices arranged at the cooling gas outlet and the cooling gas inlet, for example in an electrically controllable or manually operable manner.

The annealing material can be, for example, a grain-oriented electrical steel strip. A batch of the annealing material can be formed, for example, by winding the grain-oriented electrical steel strip into a coil or by a stack made of at least two such coils.

In accordance with an advantageous embodiment, the cooling gas system has at least one cooling gas feed communicably connected to the cooling gas outlet and the cooling gas inlet, at least one cooling unit arranged on the cooling gas feed and at least one fan arranged on the cooling gas feed. This makes it possible to circulate the cooling gas used by means of the fan in the cooling gas system and the intermediate space in communication with it and, after it has been cooled by means of the cooling unit, to feed it back to the intermediate space. For this purpose, the cooling gas feed can have at least one cooling gas line. The cooling unit can be formed as an active or passive cooling unit. The cooling unit can have at least one heat exchanger.

In accordance with a further advantageous embodiment, the base has at least two sites arranged at a distance from one another and the hood-type annealing furnace has a dedicated protective hood for each site, wherein the protective hoods can be covered with a single common heating hood, at least one cooling gas inlet is formed on the base for each site, each cooling gas inlet is connected to the at least one cooling gas outlet via the cooling gas feed and the cooling gas system has a single cooling unit arranged on the cooling gas feed and a single fan arranged on the cooling gas feed. As a result, despite the presence of at least two sites, only a single cooling unit and a single fan are required, which reduces the amount of equipment required and the associated costs, and also reduces the need for installation space. Since at least one dedicated cooling gas inlet is assigned to each site, relatively uniform simultaneous cooling of annealed annealing material can be carried out on the sites. Thereby, the cooling unit and the fan may be arranged on a common cooling gas main line of the cooling gas system, at one end of which cooling gas branch lines branch off, the number of which corresponds at least to the number of sites and which are individually connected to the respective cooling gas inlet.

In accordance with a further advantageous embodiment, the cooling gas system has at least one electrically controllable actuating device by means of which a cooling gas volume flow rate to the respective cooling gas inlet can be adjusted. Such actuating device can, for example, be arranged on a cooling gas branch line branching off from a cooling gas main line mentioned above. The cooling gas system can have a dedicated actuating device for each such branching cooling gas branch line, in order to be able to individually adjust the cooling gas volume flow rate flowing through the respective branching cooling gas branch line. This allows the simultaneous cooling of annealing material on a plurality of sites of the base to be optimized. The respective actuating device can have at least one flap arranged in the respective cooling gas branch line and at least one electrically controllable or manually operable drive actuating the flap.

In accordance with a further advantageous embodiment, the cooling gas outlet is arranged in a central region of the base located between the sites. This allows the cooling gas heated during cooling to be extracted centrally from the intermediate space, while the cooled cooling gas can be fed, for example, in peripheral regions of the intermediate space. Two or more cooling gas outlets can also be arranged in the central region of the base located between the sites.

In accordance with a further advantageous embodiment, at least a major part of the cooling gas feed, the cooling unit and the fan are arranged at the bottom below the base. As a result, the cooling gas system can largely be arranged in a region, for example in a basement of a plant located under the floor on which the base is placed, where the space conditions are less restricted than above the floor.

In accordance with a method for cooling an annealing material located in a hood-type annealing furnace using a cooling gas that, for cooling the annealing material, is passed through an intermediate space formed between a protective hood of the hood-type annealing furnace, with which the annealing material arranged on a site of a base of the hood-type annealing furnace is covered, forming an annealing space enclosed by the protective hood and the site, and a heating hood of the hood-type annealing furnace, with which the protective hood is covered, which intermediate space is bounded by the base at the bottom, the cooling gas already used for cooling is extracted from the intermediate space via at least one cooling gas outlet formed on the base and the cooling gas still to be used for cooling is introduced into the intermediate space via at least one cooling gas inlet formed on the base.

The advantages mentioned above with reference to the hood-type annealing furnace are correspondingly associated with the method. In particular, the hood-type annealing furnace in accordance with one of the above embodiments or a combination of at least two of such embodiments with one another can be used to carry out the method.

In accordance with an advantageous embodiment, the cooling gas extracted from the intermediate space is cooled by means of at least one cooling unit and then introduced into the intermediate space. With this embodiment, the advantages mentioned above with reference to the corresponding embodiment of the hood-type annealing furnace are correspondingly associated.

In accordance with a further advantageous embodiment, a cooling gas volume flow rate to the respective cooling gas inlet is adjusted individually. With this embodiment, the advantages mentioned above with reference to the corresponding embodiment of the hood-type annealing furnace are correspondingly associated.

In the following, the invention is described by way of example with reference to the accompanying the FIGURE based on a preferred embodiment, wherein the features explained below can represent an advantageous or further developing aspect of the invention both in each case individually and in combination of at least two of such features with one another.

### BRIEF DESCRIPTION OF THE DRAWINGS

FIG. 1 shows a schematic illustration of an exemplary embodiment of a hood-type annealing furnace.

### DETAILED DESCRIPTION

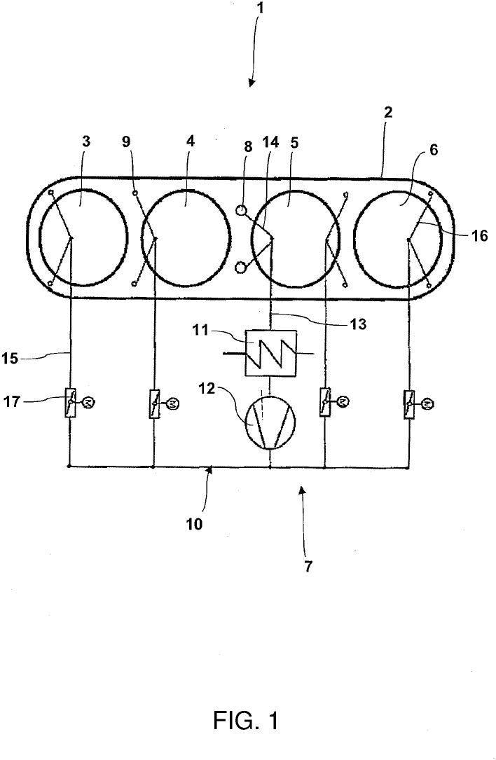

FIG. 1 shows a schematic illustration of an exemplary embodiment of a hood-type annealing furnace 1 for annealing annealing material (not shown).

The hood-type annealing furnace 1 has a base 2 that has four sites 3 to 6 arranged in a row at a distance from one another, on each of which a batch of the annealing material (not shown) is able to be arranged.

In addition, the hood-type annealing furnace 1 has a dedicated protective hood (not shown) for each site 3, 4, 5 or 6, as the case may be, with which the annealing material arranged on the respective site 3, 4, 5 or 6, as the case may be, is able to be covered, forming in each case an annealing space (not shown) enclosed by the respective protective hood and the respective site 3, 4, 5 or 6, as the case may be.

In addition, the hood-type annealing furnace 1 has a single heating hood (not shown), with which the protective hoods are able to be covered, forming an intermediate space (not shown) arranged between the heating hood and the protective hoods and bounded at the bottom side by the base 2.

Further, the hood-type annealing furnace 1 has a cooling gas system 7 that is communicably connected or connectable to the intermediate space. The cooling gas system 7 is communicably connected or connectable to the intermediate space via two cooling gas outlets 8 formed on the base 2 and communicably connected to the intermediate space, and eight cooling gas inlets 9 formed on the base 2 and communicably connected to the intermediate space. The cooling gas outlets 8 are arranged in a central region of the base 2 located between the sites 3 and 4, on the one hand, and 5 and 6, on the other hand. The cooling gas inlets 9 are provided in pairs for each site 3, 4, 5 or 6, as the case may be, such that two cooling gas inlets 9 are formed on the base 2 for each site 3, 4, 5 or 6, as the case may be.

The cooling gas system 7 has a cooling gas feed 10 communicably connected to the cooling gas outlets 8 and the cooling gas inlets 9, a single cooling unit 11 arranged on the cooling gas feed 10 and a single fan 12 arranged on the cooling gas feed 10. Each cooling gas inlet 9 is connected to the cooling gas outlets 8 via the cooling gas feed 10.

The cooling gas feed 10 has a cooling gas main line 13 on which the cooling unit 11 and the fan 12 are arranged. The cooling gas main line 13 is connected at one end to the cooling gas outlets 8 via cooling gas branch lines 14. The other end of the cooling gas main line 13 is connected to cooling gas branch lines 15, the other ends of which are in turn connected to the cooling gas inlets 9 via two cooling gas branch lines 16.

The cooling gas system 7 has four electrically controllable actuating devices 17, each of which is arranged on one of the cooling gas branch lines 15 and by means of which a cooling gas volume flow rate to the respective pair of cooling gas inlets 9 can be individually adjusted.

At least a major part of the cooling gas feed 10, the cooling unit 11 and the fan 12 are arranged at the bottom below the base 2, which is not shown in FIG. 1 for reasons of clarity.

The articles “a” and “an” as used in this application should generally be construed to mean “one or more” unless specified otherwise or clear from context to be directed to a singular form.

LIST OF REFERENCE SIGNS

| | |
|---|---|
| 1 | Hood-type annealing furnace |
| 2 | Base |
| 3 | Site |
| 4 | Site |
| 5 | Site |
| 6 | Site |
| 7 | Cooling gas system |
| 8 | Cooling gas outlet |
| 9 | Cooling gas inlet |
| 10 | Cooling gas feed |
| 11 | Cooling unit |
| 12 | Fan |
| 13 | Cooling gas main line |
| 14 | Cooling gas branch line |
| 15 | Cooling gas branch line |
| 16 | Cooling gas branch line |
| 17 | Actuating device |

1-9. (canceled)

10. A hood-type annealing furnace (1) for annealing an annealing material, comprising:
a base (2), having a site (3, 4, 5, 6) on which a batch of the annealing material is able to be arranged;
a protective hood, with which the annealing material arranged on the site (3, 4, 5, 6) is able to be covered, forming an annealing space enclosed by the protective hood and the site (3, 4, 5, 6);
a heating hood, with which the protective hood is able to be covered, forming an intermediate space arranged between the heating hood and the protective hood and bounded at a bottom by the base (2); and
a cooling gas system (7) that is communicably connected or connectable to the intermediate space by
a cooling gas outlet (8) formed on the base (2) and by
a cooling gas inlet (9) formed on the base (2).

11. The hood-type annealing furnace (1) according to claim 10, wherein the cooling gas system (7) comprises
a cooling gas feed (10) communicably connected to the cooling gas outlet (8) and the cooling gas inlet (9),
a cooling unit (11) arranged on the cooling gas feed (10) and
a fan (12) arranged on the cooling gas feed (10).

12. The hood-type annealing furnace (1) according to claim 11,
wherein one or more of the cooling gas feed (10), the cooling unit (11), and the fan (12) are arranged below the base (2).

13. A hood-type annealing furnace (1), comprising:
a base (2), having at least two sites (3, 4, 5, 6) arranged at a distance from one another (3, 4, 5, 6), each of the at least two sites (3, 4, 5, 6) being configured to receive a batch of an annealing material;
at least two protective hoods with which the respective batches of the annealing material arranged on the at least two sites (3, 4, 5, 6) are able to be covered, each protective hood being dedicated to forming an annealing space enclosed by the respective protective hood and a corresponding one of the at least two sites (3, 4, 5, 6);
a single heating hood, with which the at least two protective hoods are able to be covered, forming an intermediate space between the heating hood and the at least two protective hoods that is bounded at a bottom by the base (2); and
a cooling gas system (7) that is communicably connected or connectable to the intermediate space by
a cooling gas outlet (8) formed on the base (2) and by
a cooling gas inlet (9) formed on the base (2) for each of the at least two sites (3, 4, 5, 6),
wherein each cooling gas inlet (9) is connected to the cooling gas outlet (8) via a cooling gas feed (10), and
wherein the cooling gas system (7) has a single cooling unit (11) arranged on the cooling gas feed (10) and a single fan (12) arranged on the cooling gas feed (10).

14. The hood-type annealing furnace (1) according to claim 13,
wherein the cooling gas system (7) has an electrically controllable actuating device (17) by which a cooling gas volume flow rate to the respective cooling gas inlet (9) can be adjusted.

15. The hood-type annealing furnace (1) according to claim 14,
wherein the cooling gas outlet (8) is arranged in a central region of the base (2) located between the at least two sites (3, 4, 5, 6).

16. The hood-type annealing furnace (1) according to claim 13,
wherein one or more of the cooling gas feed (10), the cooling unit (11), and the fan (12) are arranged below the base (2).

17. A method for cooling an annealing material located in a hood-type annealing furnace (1), comprising:
arranging a protective hood to cover the annealing material arranged on a site (3, 4, 5, 6) of a base (2) of the hood-type annealing furnace (1) and thereby forming an annealing space enclosed by the protective hood and the site (3, 4, 5, 6);
arranging a heating hood to cover the protective hood, thereby forming an intermediate space between the protective hood and the heating hood that is bounded at a bottom by the base (2);
passing a cooling gas, for cooling the annealing material, through the intermediate space;
extracting used cooling gas from the intermediate space via at least one cooling gas outlet (8) formed on the base (2); and
introducing fresh cooling gas into the intermediate space via at least one cooling gas inlet (9) formed on the base (2).

18. The method according to claim 17, further comprising
cooling the used cooling gas by a cooling unit (11) to produce the fresh cooling gas.

19. The method according to claim 17, further comprising
individually adjusting a cooling gas volume flow rate to the respective cooling gas inlet (9).
